(19) United States
(12) Patent Application Publication
(10) Pub. No.: US 2026/0224415 A1
(43) Pub. Date: Aug. 6, 2026

(54) DOCKING DEVICE FOR WHEELCHAIRS

(71) Applicant: MASKINFABRIK DAHL ENGINEERING APS, Thisted (DK)

(72) Inventor: Claus Dahl Pedersen, Thisted (DK)

(21) Appl. No.: 19/156,935

(22) PCT Filed: Jan. 19, 2024
(86) PCT No.: PCT/EP2024/051215

§ 371 Date: Aug. 15, 2025

(30) Foreign Application Priority Data
Feb. 28, 2024 (DK) PA202300182

(51) Int. Cl. A61G 3/08

(52) U.S. Cl. CPC A61G 3/0808

(57) ABSTRACT

A docking device for being mounted on, preferably beneath, a wheelchair is shown. The docking device includes a chassis, fastening means adapted for securing the docking device to the wheelchair; and an auxiliary means, such as a first female or male docking fixture, an auxiliary drive unit, parts of an auxiliary drive unit, a battery pack, or a shelf. The first docking fixture is adapted for being directly or indirectly mounted to the chassis, and the fastening means includes a first set of brackets adapted for being mounted to the wheelchair, and a first mounting rod mounted to the chassis and adapted for releasably fastening to the first set of brackets.

### TECHNICAL FIELD OF THE INVENTION

The present invention relates to transportation of wheelchair users, and more particularly to means adapted to secure the wheelchair into a transport vehicle.

### BACKGROUND OF THE INVENTION

The welfare and safety of persons being transported in wheelchairs is of ever-increasing concern, and many jurisdictions have enacted stringent safety requirements for devices to secure the wheelchair into the transport vehicle and the occupant into the wheelchair. Numerous solutions, most of which are reasonably effective, have been suggested in the prior art, but they frequently require the attachment of a plurality of straps or the like to one or more anchor points in the transport vehicle. After attachment, the straps must be tightened either by the wheelchair occupant or by an attendant. There have been some attempts to provide self-attachment devices in the past and attention is directed to U.S. Pat No. 7,229,238 in which a locking mechanism is secured beneath a wheelchair and releasably locked to a docking station similarly mounted under the wheelchair, on the floor of the vehicle. While reasonably effective in certain circumstances, it does not solve the problem that some wheelchairs are constructed to be folded for e.g., storage. A permanent mounted locking mechanism secured beneath a foldable wheelchair will prevent it from being folded, thereby depriving it from one of its preferred functions. U.S. Pat. No. 4,730,964 discloses an electromechanical system for securing a foldable wheelchair to the floor of a transportation vehicle. The system is operable using a multiple position switch, which controls a motor actuated tie down hook and a pair of adjustable chocks so that the wheelchair wheels are secured directly to the vehicle floor with the wheelchair remaining in a horizontal position.

However, this solution requires that a triangular shaped adjustable tie-down bracket is permanently connected to the foldable wheelchair's cross-braces by bolts.

Hence, there is a need for a docking device for securement beneath a foldable wheelchair that solves the above-mentioned problems.

### SUMMARY OF THE INVENTION

A first aspect relates to a docking device adapted for being mounted on a wheelchair and adapted for releasably securing a wheelchair to the floor of a transport vehicle, said docking device comprising:
a chassis;
fastening means adapted for securing the docking device to the wheelchair; and
a first female or male docking fixture adapted for locking engagement with a second male or female docking fixture mounted to the floor of a transport vehicle, said first docking fixture being adapted for being directly or indirectly mounted to said chassis;
   wherein the fastening means comprises:
a first set of brackets adapted for being mounted to the wheelchair; and
a first mounting rod mounted to the chassis and adapted for releasably fastening to said first set of brackets.

A second aspect relates to a docking system for releasably securing a wheelchair to the floor of a transport vehicle, said system comprising:
a docking device according to the present invention; and
a second male or female docking fixture adapted for being mounted to the floor of the transport vehicle, and adapted for engaging with the first female or male docking fixture of said docking device.

A third aspect relates to a docking device adapted for being mounted on a wheelchair, and preferably adapted for releasably securing a wheelchair to the floor of a transport vehicle, said docking device comprising:
a chassis;
fastening means adapted for securing the docking device to the wheelchair; and
auxiliary means, such as a first female or male docking fixture, an auxiliary drive unit, parts of an auxiliary drive unit, a battery pack, or a shelf, said auxiliary means adapted for being directly or indirectly mounted to said chassis;
   wherein the fastening means comprises:
a first set of brackets adapted for being mounted to the wheelchair; and
a first mounting rod mounted to the chassis and adapted for releasably fastening to said first set of brackets.

A fourth aspect relates to a docking device adapted for being mounted on a wheelchair, said docking device comprising:
a chassis;
fastening means adapted for securing the docking device to the wheelchair; and
auxiliary means, such as a first female or male docking fixture, an auxiliary drive unit, parts of an auxiliary drive unit, a battery pack, or a shelf, said auxiliary means adapted for being directly or indirectly mounted to said chassis;
   wherein the fastening means comprises:
a first set of brackets adapted for being mounted to the wheelchair; and
a first mounting rod mounted to the chassis and adapted for releasably fastening to said first set of brackets.

A fifth aspect relates to a docking device adapted for being mounted on a wheelchair, said docking device comprising:
a chassis;
fastening means adapted for securing the docking device to the wheelchair; and
auxiliary means, such as a first female or male docking fixture, an auxiliary drive unit, parts of an auxiliary drive unit, a battery pack, or a shelf, said auxiliary means adapted for being directly or indirectly mounted to said chassis;
   wherein the fastening means comprises:
a first set of brackets adapted for being mounted to the wheelchair; and
a first mounting rod mounted to the chassis and adapted for releasably engagement to said first set of brackets.

A sixth aspect relates to a docking device adapted for being mounted on a wheelchair, said docking device comprising:
a chassis;
fastening means adapted for securing the docking device to the wheelchair; and
auxiliary means, such as a first female or male docking fixture, an auxiliary drive unit, parts of an auxiliary drive unit, a battery pack, or a shelf, said auxiliary means adapted for being directly or indirectly mounted to said chassis;
   wherein the fastening means comprises:
a first set of brackets adapted for being mounted to the wheelchair; and
a first mounting rod mounted to the chassis and adapted for releasably engagement and/or releasably fastening to said first set of brackets.

In general, the docking device is preferably adapted for being mounted beneath a wheelchair.

The docking device may in some embodiments solely be interpreted to be docked to the wheelchair, and in other embodiments interpreted as a traditional docking device for releasably securing a wheelchair to the floor of a transport vehicle. In the former case, the docking device's main function is to function as support for the auxiliary means, although it may also function to prevent a foldable wheelchair from folding during use.

In one or more embodiments, the auxiliary means is selected from the group consisting of an auxiliary drive unit, parts of an auxiliary drive unit, a battery pack, or a shelf.

In one or more embodiments, the wheelchair is a foldable wheelchair, and wherein the docking device is adapted for preventing the wheelchair from folding when mounted thereto.

In one or more embodiments, the auxiliary means is a first female or male docking fixture adapted for locking engagement with a respective second male or female docking fixture mounted to the floor of a transport vehicle.

The fastening means may have many different configurations, but as a minimum comprising a first set of brackets adapted for being mounted to the wheelchair, and a first mounting rod mounted to the chassis and adapted for releasably fastening to said first set of brackets.

In one or more embodiments, the first mounting rod comprises a first end and an opposite second end, and wherein each end is configured as a locking pin adapted for releasably engagement with a respective bracket of said first set of brackets. The locking pin may comprise a neck and a head. The bracket may comprise a recess adapted for receiving the neck of the locking pin. The head of the locking pin may be wider than the recess, thereby restricting movement of the first mounting rod during impact.

In one or more embodiments, each bracket of said first set of brackets comprises a cavity; wherein the fastening means further comprises a pair of sleeve units each adapted for sliding back and forth on said first mounting rod between an extended position and a retracted position relative to the first or second end, respectively, of said first mounting rod, wherein each sleeve unit of said pair of sleeve units comprises a first end and a second end, wherein the first end of each sleeve unit is configured for releasably engagement with a cavity of a respective bracket of said first set of brackets.

In one or more embodiments, each sleeve unit comprises a spring-loaded mechanism configured for forcing said sleeve unit towards its extended position and for resiliently allowing said sleeve unit to be positioned in its retracted position by a user.

In one or more embodiments, the docking device further comprises:
a second set of brackets adapted for being mounted to the wheelchair; and
a second mounting rod mounted to the chassis and adapted for releasably fastening to said second set of brackets.

Preferably, the first mounting rod is mounted at the rear end of the wheelchair, and the second mounting rod is mounted at the front end of the wheelchair, or vice versa.

Further pairs of brackets and mounting rods may be possible.

In one or more embodiments, the second mounting rod comprises a first end and an opposite second end, and wherein each end is configured as a locking pin adapted for releasably engagement with a respective bracket of said second set of brackets.

In one or more embodiments, each bracket of said second set of brackets comprises a cavity; wherein the fastening means further comprises a pair of sleeve units each adapted for sliding back and forth on said second mounting rod between an extended position and a retracted position relative to the first or second end, respectively, of said second mounting rod, wherein each sleeve unit of said pair of sleeve units comprises a first end and a second end, wherein the first end of each sleeve unit is configured for releasably engagement with a cavity of a respective bracket of said second set of brackets.

In one or more embodiments, each sleeve unit comprises a spring-loaded mechanism configured for forcing said sleeve unit towards its extended position and for resiliently allowing said sleeve unit to be positioned in its retracted position by a user.

It may be an advantage to use a different configuration of brackets and mounting rods for the rear end and the front end of the wheelchair for easier mounting of the docking device In one or more embodiments, each bracket of said second set of brackets comprises a hook-shaped part adapted for releasable and hinged engagement with a respective locking pin of said second mounting rod. This embodiment allows a user to first mount the second mounting rod and then use it as a hinge to lift the first mounting rod into place. In one or more embodiments, the hook-shaped part is configured for being adjusted from a retracted position relative to the remaining part of the bracket to one or more extended positions relative to the remaining part of the bracket, or vice versa.

In one or more embodiments, the locking pin comprises a neck and a head, wherein the hook-shaped part defines a recess adapted for receiving the neck of the locking pin, wherein the head of the locking pin is wider than the recess, thereby restricting movement of the second mounting rod during impact.

In one or more embodiments, the hook-shaped part comprises a shaft configured for being adjusted from a retracted position relative to the remaining part of the bracket that is shaped as a clamp unit, to one or more extended positions relative to said clamp unit, or vice versa.

The docking device is preferably U-shaped or tubular. This is to provide space for tools to handle (tighten or loosen) bolt nuts or screws mounted or being part of the docking device when adjustments are needed.

The chassis may have many different configurations. Some of its functions are to provide support for other parts, such as the fastening means, and the docking fixture, and for taking part in adjustment features.

The first female or male docking fixture may have many different configurations e.g., depending on the configuration of the second male or female docking fixture mounted to the floor of the transport vehicle. The docking fixture may e.g., be a male docking fixture, and e.g., comprise an upper portion (in use), a middle-positioned neck portion, and a lower positioned head portion. In order to induce mechanical strength into the docking fixture, the upper portion (in use) may be configured with a bottom plate (in use) with walls (e.g., two opposite side walls, and two opposite end walls, in use) optionally extending upwards therefrom. The walls, preferably the side walls, may be provided with the above disclosed bolt holes and/or guide recesses formed in the docking fixture.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a perspective view of a docking device in accordance with various embodiments of the invention.

FIG. 2A shows a docking device in accordance with various embodiments of the invention mounted on a wheelchair.

FIG. 2B shows a closeup view of a part of FIG. 2A.

FIG. 3 shows a bottom view of a part of a wheelchair with a docking device in accordance with various embodiments of the invention mounted thereon.

FIGS. 4A-C show the process of dismounting a mounting rod end from a bracket.

FIGS. 5A-C show the process of dismounting a mounting rod end from a bracket.

FIG. 6 is a perspective and partly transparent view of a mounting rod end in accordance with various embodiments of the invention.

FIG. 7 is a perspective of a bracket in accordance with various embodiments of the invention.

FIG. 8 is a perspective of a docking fixture mounted to a part of the chassis.

### DETAILED DESCRIPTION OF THE INVENTION

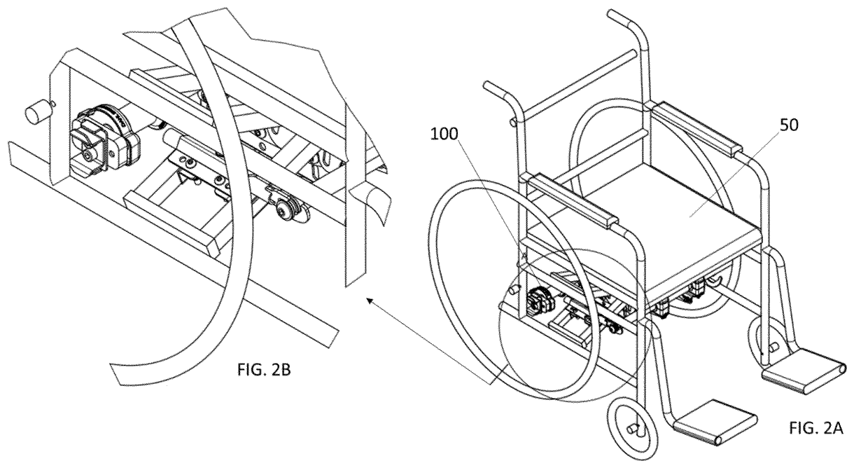

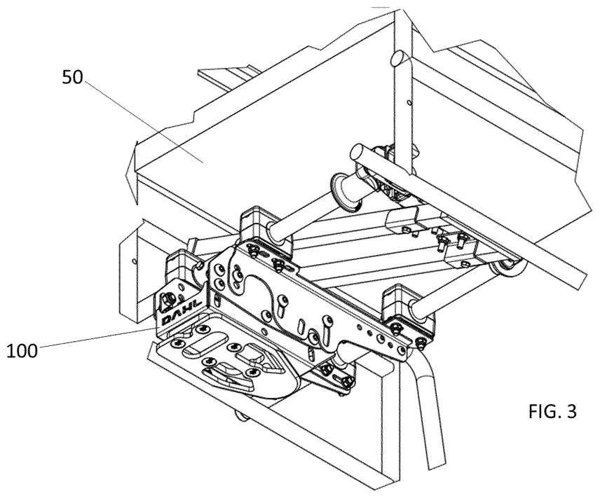

Referring to FIGS. 2A-B, the general scheme of the invention is shown. FIGS. 2A-B show a docking device 100 mounted on the chassis of a foldable wheelchair 50 and adapted for releasably securing the wheelchair 50 to the floor of a transport vehicle (not shown). A bottom view of a part of the wheelchair 50 is shown in FIG. 3 to better show the position of the docking device 100.

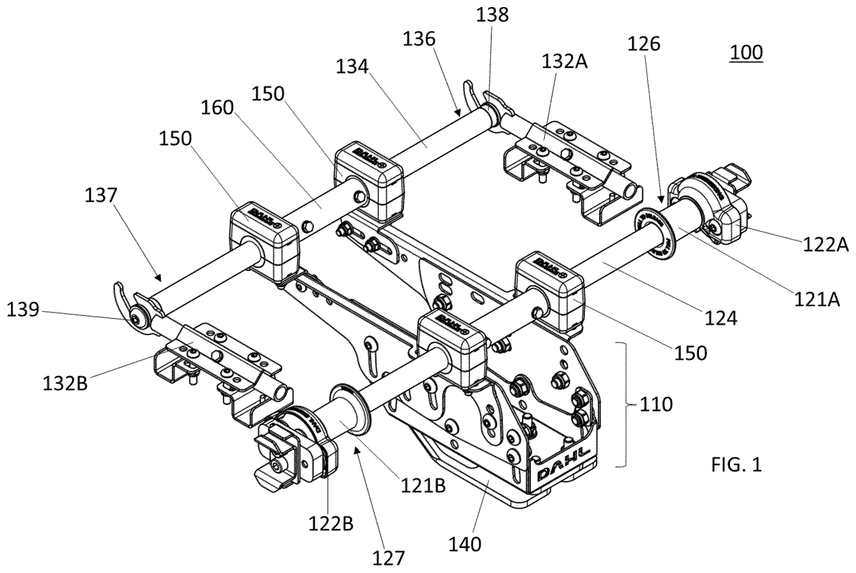

Now referring to FIG. 1 for a better view of the docking device 100. The docking device 100 comprises a first set of brackets 122A, 122B adapted for being mounted to the wheelchair 50, and a first mounting rod 124 mounted to the chassis 110 and adapted for releasably fastening to the first set of brackets 122A, 122B. This configuration allows the docking device 100 to be mounted to the wheelchair 50, while at the same time preventing the foldable wheelchair 50 to collapse during impact in an accident. Such a collapse would otherwise result in the docking device 100 loosening its grip of the wheelchair 50. It may be necessary to include two or more mounting rods in the docking device 100 and with respective brackets. In the shown embodiment, the docking device 100 also comprises a second set of brackets 132A, 132B adapted for being mounted to the wheelchair 50; and a second mounting rod 134 mounted to the chassis 110 and adapted for releasably fastening to said second set of brackets 132A, 132B. One of the sets are mounted to the rear end of the wheelchair 50, and the other set is mounted to the front end of the wheelchair 50, while the mounting rods each span from one side of the wheelchair 50 to the other. Here, the second set of brackets 132A, 132B, and the second mounting rod 134 is shown mounted to the front end of the wheelchair 50, while the first set of brackets 122A, 122B, and the first mounting rod 124 is mounted to the rear end of the wheelchair 50. This could also be the other way around.

To allow for an easier mounting operation, the two sets of brackets 122, 132 and mounting rods 124, 134 are configured differently.

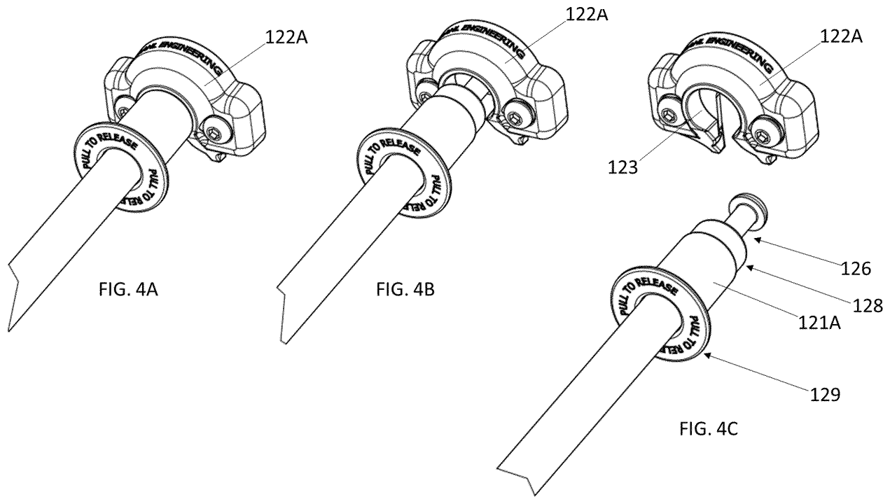

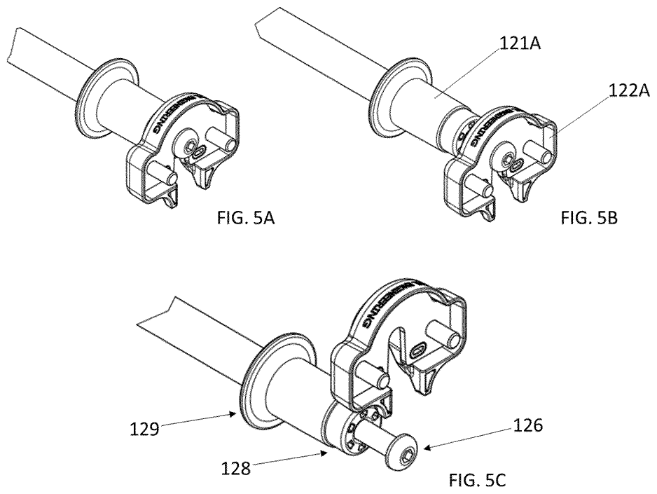

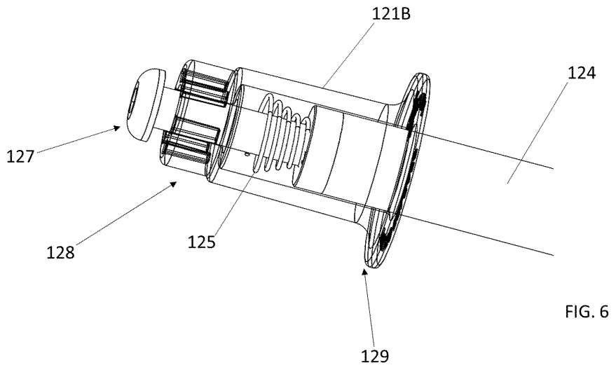

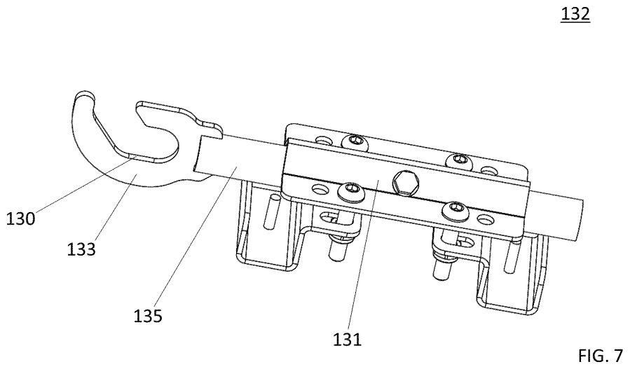

The first mounting rod 124 comprises a first end 126, and an opposite second end 127 (see FIG. 1). Each end 126, 127 (FIGS. 4 and 5 show the first end, whole FIG. 6 shows the second end) is configured as a locking pin adapted for releasably engagement with a respective bracket 122A, 122B of said first set of brackets 122A, 122B. The locking pin is here shown with a head and a neck. The neck is configured to fit into a recess of the bracket, while the head aids in restricting the movement of the locking pin relative to the bracket once the two are connected. Each bracket 122A, 122B also comprises a cavity 123, here shown flanking the recess. The fastening means is shown further comprising a pair of sleeve units 121A, 121B each adapted for sliding back and forth on the first mounting rod 124 between an extended position (FIGS. 4A and 5A) and a retracted position (FIGS. 4B and 5B) relative to the first 126 or second end 127, respectively, of the first mounting rod 124. Each sleeve unit 121A, 121B comprises a first end 128 and a second end 129, wherein the first end 128 of each sleeve unit 121A, 121B is configured for releasably engagement with a cavity 123 of a respective bracket 122A, 122B. Hence, in the extended position, the sleeve unit 121A is locked to the bracket 122A (FIGS. 4A and 5A), and in the retracted position, the sleeve unit 121A is unlocked from the bracket 122A (FIGS. 4B and 5B).

Each sleeve unit 121A, 121B is shown (see FIG. 6) comprising a spring-loaded mechanism with a spring 125 configured for forcing the sleeve unit 121A, 121B towards its extended position and for resiliently allowing said sleeve unit 121A, 121B to be positioned in its retracted position by a user.

The second mounting rod 134 comprises a first end 136 and an opposite second end 137. As the first mounting rod 124, each end 136, 137 is configured as a locking pin adapted for releasably engagement with a respective bracket 132A, 132B of the second set of brackets 132A, 132B. The locking pin is shown (see FIG. 1) comprising a neck 138 and a head 139. Each bracket 132A, 132B comprises a hook-shaped part 133 adapted for releasable and hinged engagement with a respective locking pin of the second mounting rod 134. The hook-shaped part 133 defines a recess 130 adapted for receiving the neck 138 of the locking pin, while the head 139 of the locking pin is wider than the recess 130, thereby restricting movement of the second mounting rod 134 during impact.

The hook-shaped part 133 comprises a shaft 135 that is configured for being adjusted from a retracted position relative to the remaining part of the bracket 131, here in the form of a clamp unit, to one or more extended positions relative to the clamp unit 131, or vice versa. Obviously, the clamp unit 131 may be configured for different shapes of tubes of the wheelchair chassis, and may e.g., be adapted for being mounted to the scissor mechanism.

The first 124 and second 134 mounting rods are connected to the chassis with clamping units 150, here two clamping units 150 for each (see FIG. 1). Both the first 124 and second 134 mounting rods may comprise two or more sections that are connected to one another, e.g., by one or more clamps. In FIG. 1, the first 124 and second 134 mounting rods are shown comprising two pipe/rod sections connected with a clamp 160 at the middle of the rod, i.e., between the clamping units 150. This is to be able to adjust the docking device for different widths of wheelchairs. The clamp 160 could be replaced by a treaded tube section that is adapted for receiving an end section of the two tube or rod sections. In this configuration, the width of the mounting rods may be adjusted by screwing the end sections into the treaded tube section.

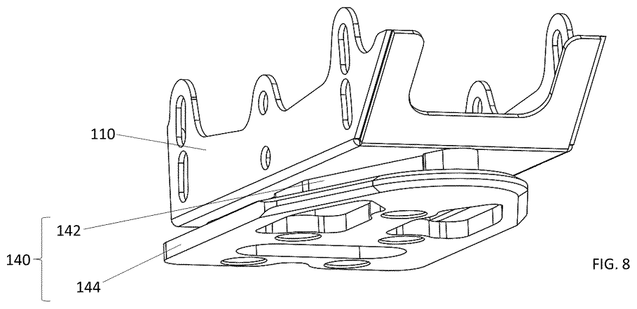

The docking device 100 is U-shaped or tubular. This is to provide space for tools to handle (tighten or loosen) the bolt nuts when adjustments are needed. The docking fixture 140 could have many different configurations but is here shown with a neck portion 142, and a lower positioned head portion 144 (see FIG. 8).

### REFERENCES

50 Wheelchair
100 Docking device
110 Chassis
121 Sleeve unit
122 Bracket
123 Cavity
124 First mounting rod
125 Spring
126 First end
127 Second end
128 First end
129 Second end
130 Recess
131 Clamp unit
132 Bracket
133 Hook-shaped part
134 Second mounting rod
135 Shaft
136 First end
137 Second end
138 Neck
139 Head
140 First docking fixture
142 Neck portion
144 Head portion
150 Clamp unit
160 Clamp unit

1. A docking device (100) configured for mounting on a wheelchair (50), said docking device (100) comprising:
a chassis (110);
fastening means for securing the docking device (100) to the wheelchair (50); and
auxiliary means, such as a first female or male docking fixture (140), an auxiliary drive unit, parts of an auxiliary drive unit, a battery pack, or a shelf, said auxiliary means for direct or indirect mounting to said chassis (110);
wherein the fastening means comprises:
a first set of brackets (122A, 122B) for mounting to the wheelchair (50); and
a first mounting rod (124) mounted to the chassis (110) for releasable engagement to said first set of brackets (122A, 122B);
wherein the first mounting rod (124) comprises a first end (126) and an opposite second end (127), and wherein each end (126, 127) is configured as a locking pin for releasable engagement with a respective bracket (122A, 122B) of said first set of brackets (122A, 122B).

2. The docking device (100) according to claim 1, wherein the auxiliary means is a first female or male docking fixture (140) for locking engagement with a respective second male or female docking fixture mounted to the floor of a transport vehicle.

3. The docking device (100) according to claim 1, wherein each bracket (122A, 122B) of said first set of brackets (122A, 122B) comprises a cavity (123); wherein said fastening means further comprises a pair of sleeve units (121A, 121B) each for sliding back and forth on said first mounting rod (124) between an extended position and a retracted position relative to the first (126) or second end (127), respectively, of said first mounting rod (124), wherein each sleeve unit (121A, 121B) of said pair of sleeve units (121A, 121B) comprises a first end and a second end, wherein the first end of each sleeve unit (121A, 121B) is configured for releasable engagement with the cavity (123) of a respective bracket (122A, 122B) of said first set of brackets (122A, 122B).

4. The docking device (100) according to claim 3, wherein each sleeve unit (121A, 121B) comprises a spring-loaded mechanism (125) configured for forcing said sleeve unit (121A, 121B) towards its extended position and for resiliently allowing said sleeve unit (121A, 121B) to be positioned in its retracted position by a user.

5. The docking device (100) according to claim 1, further comprising:
a second set of brackets (132A, 132B) for mounting to the wheelchair (50); and
a second mounting rod (134) mounted to the chassis (110) for releasable engagement to said second set of brackets (132A, 132B).

6. The docking device (100) according to claim 5, wherein the second mounting rod (134) comprises a first end (136) and an opposite second end (137), and wherein each end (136, 137) is configured as a locking pin for releasable engagement with a respective bracket (132A, 132B) of said second set of brackets (132A, 132B).

7. The docking device (100) according to claim 6, wherein each bracket (132A, 132B) of said second set of brackets (132A, 132B) comprises a hook-shaped part (133) for releasable and hinged engagement with a respective locking pin of said second mounting rod (134).

8. The docking device (100) according to claim 7, wherein said hook-shaped part (133) is configured for being adjusted from a retracted position relative to the remaining part of the bracket to one or more extended positions relative to the remaining part of the bracket, or vice versa.

9. The docking device (100) according to claim 7, wherein the locking pin comprises a neck (138) and a head (139), wherein the hook-shaped part (133) defines a recess (130) for receiving the neck (138) of the locking pin, wherein the head (139) of the locking pin is wider than the recess (130), thereby restricting movement of the second mounting rod (134) during impact.

10. The docking device (100) according to claim 7, wherein the hook-shaped part (133) comprises a shaft (135) configured for being adjusted from a retracted position relative to the remaining part of the bracket (131) that is shaped as a clamp unit, to one or more extended positions relative to said clamp unit (131), or vice versa.

11. The docking device (100) according to claim 6, wherein each bracket (132A, 132B) of said second set of brackets (132A, 132B) comprises a cavity; wherein the fastening means further comprises a pair of sleeve units each adapted for sliding back and forth on said second mounting rod between an extended position and a retracted position relative to the first or second end, respectively, of said second mounting rod, wherein each sleeve unit of said pair of sleeve units comprises a first end and a second end, wherein the first end of each sleeve unit is configured for releasable engagement with a cavity of a respective bracket of said second set of brackets.

12. The docking device (100) according to claim 11, wherein each sleeve unit comprises a spring-loaded mechanism configured for forcing said sleeve unit towards its extended position and for resiliently allowing said sleeve unit to be positioned in its retracted position by a user.

13. The docking device (100) according to claim 1, wherein the auxiliary means is selected from the group consisting of an auxiliary drive unit, parts of an auxiliary drive unit, a battery pack, or a shelf.

14. A docking system adapted for releasably securing a wheelchair to the floor of a transport vehicle, said system comprising:
a docking device (100) according to claim 2; and
a second male or female docking fixture adapted for being mounted to the floor of the transport vehicle, and adapted for engaging with the first female or male docking fixture (140) of said docking device (100).

15. The docking system according to claim 14, wherein the wheelchair is a foldable wheelchair, and wherein the docking device (100) is configured for preventing the wheelchair from folding when mounted thereto.
